(19) United States
(12) Patent Application Publication
(10) Pub. No.: US 2013/0068264 A1
(43) Pub. Date: Mar. 21, 2013

(54) WAFER SCRUBBER APPARATUS

(71) Applicants: Jeng-Hsing Jang, Taoyuan County (TW); Yi-Nan Chen, Taoyuan County (TW); Hsien-Wen Liu, Taoyuan County (TW)

(72) Inventors: Jeng-Hsing Jang, Taoyuan County (TW); Yi-Nan Chen, Taoyuan County (TW); Hsien-Wen Liu, Taoyuan County (TW)

(73) Assignee: NANYA TECHNOLOGY CORPORATION, Taoyuan (TW)

(21) Appl. No.: 13/238,929

(22) Filed: Sep. 21, 2011

(51) Int. Cl. B08B 3/00

(52) U.S. Cl. 134/157

(57) ABSTRACT

A wafer scrubber apparatus is disclosed, including a chamber, and holder connecting to a spindle disposed in the chamber, wherein the holder supports a wafer, and a gas purge pipe disposed at the top of a wall of the chamber, wherein the gas purge pipe comprises a plurality of gas injection holes facing downward to purge gas along the chamber wall making water flow along the chamber wall more smoothly and more quickly for preventing the water from scattering back to the wafer.

### BACKGROUND OF THE INVENTION

1. Field of the Invention

This invention generally relates to a wafer scrubber apparatus and more particularly to a wafer scrubber apparatus using a high speed spinning action to remove water from a surface of a wafer.

2. Description of the Related Art

Production of semiconductor devices having microscopic structures require high-precision technology. During processing, minute particles of dust on the circuits which constitute a semiconductor device may degrade the reliability of a finished semiconductor device. Even if dust contaminants produced during processing, which end up on a semiconductor wafer, do not adversely affect the circuit functions of the semiconductor device, they still may lead to fabrication difficulties. Therefore, a semiconductor device must be fabricated in a dirt-free environment, and the surface of the semiconductor wafer must be washed to remove minute particles of dust generated during processing.

Referring to FIG. 1, a conventional wafer scrubber apparatus comprises a spindle 106 connected to a holder 110 for holding a wafer 102. The wafer 102 is moistened by deionized water 108 (DI water) in a preceding stage. The wafer 102 and the holder 110 spin with a high speed to remove water 108 from the surface of the wafer. However, this method and apparatus leads the water 108 leaving the wafer 102 with a high speed and the wafer 102 is close to the chamber wall, so that the high speed water 108 hitting the chamber wall 104 scatters back to impact the wafer 102. Therefore, particle and chip damage issues are generated.

### BRIEF SUMMARY OF INVENTION

The invention provides a wafer scrubber apparatus, comprising a chamber, and holder connecting to a spindle disposed in the chamber, wherein the holder supports a wafer, and a gas purge pipe disposed at the top of a wall of the chamber, wherein the gas purge pipe comprises a plurality of gas injection holes facing downward to purge gas along the chamber wall making water flow along the chamber wall more smoothly and more quickly for preventing the water from scattering back to the wafer.

The invention further provides a wafer cleaning procedure, comprising providing a wafer scrubber apparatus, comprising a chamber, and holder connecting to a spindle disposed in the chamber, wherein the holder supports a wafer and a gas purge pipe disposed at the top of a wall of the chamber, and spinning the wafer to remove water thereon, wherein the gas purge pipe purges gas along the wall of the chamber making water flow along the wall of the chamber more smoothly and more quickly for preventing the water from scattering back to the wafer.

### BRIEF DESCRIPTION OF DRAWINGS

The invention can be more fully understood by reading the subsequent detailed description and examples with references made to the accompanying drawings, wherein,

FIG. 1 shows a conventional wafer scrubber apparatus.

FIG. 2 shows a method to reduce the wafer scattering back issue.

FIG. 3A shows a cross section view of a wafer scrubber apparatus of an embodiment of the invention.

FIG. 3B shows a three dimensional view of a wafer scrubber apparatus of an embodiment of the invention.

FIG. 4A shows a cross section view of a wafer scrubber apparatus of another embodiment of the invention.

FIG. 4B shows a three dimensional view of a wafer scrubber apparatus of another embodiment of the invention.

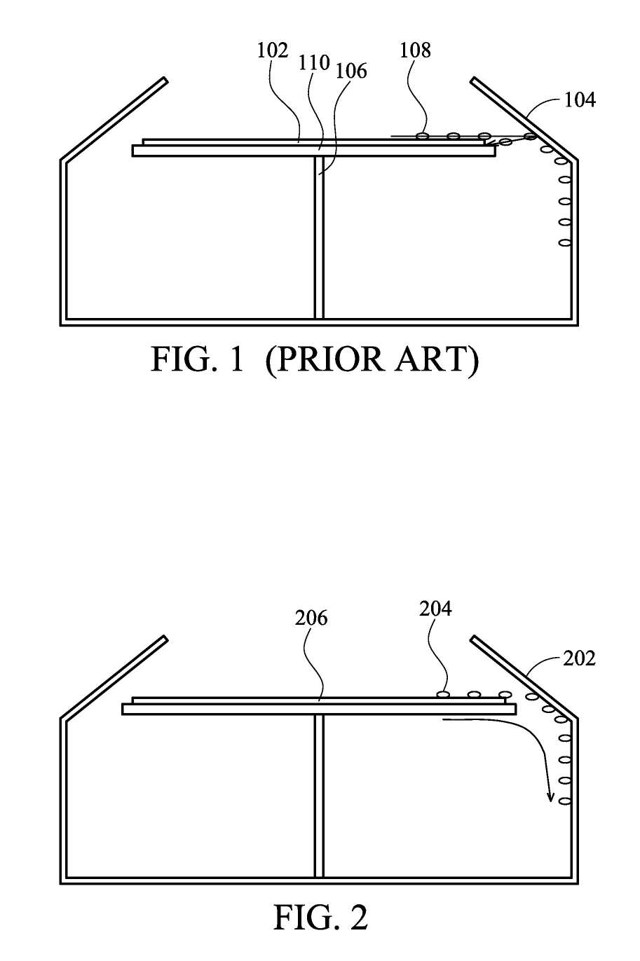

### DETAILED DESCRIPTION OF INVENTION

It is understood that specific embodiments are provided as examples to teach the broader inventive concept, and one of ordinary skill in the art can easily apply the teaching of the present disclosure to other methods or apparatus. The following discussion is only used to illustrate the invention, not limit the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

FIG. 2 shows a method to reduce the wafer scattering back issue. Referring to FIG. 2, it is found that a hydrophilic surface of an inner cup 202 can reduce the water scattering back issue. Therefore, the method changes material of the inner wall to have a hydrophilic surface for preventing water 204 from scattering back to hit the wafer 206 which generates particle and/or chip damage issues. However, this method cannot completely eliminate the water 204 scattering back issue.

Accordingly, a new scrubber cleaning apparatus and method are required to address the water scattering back issues

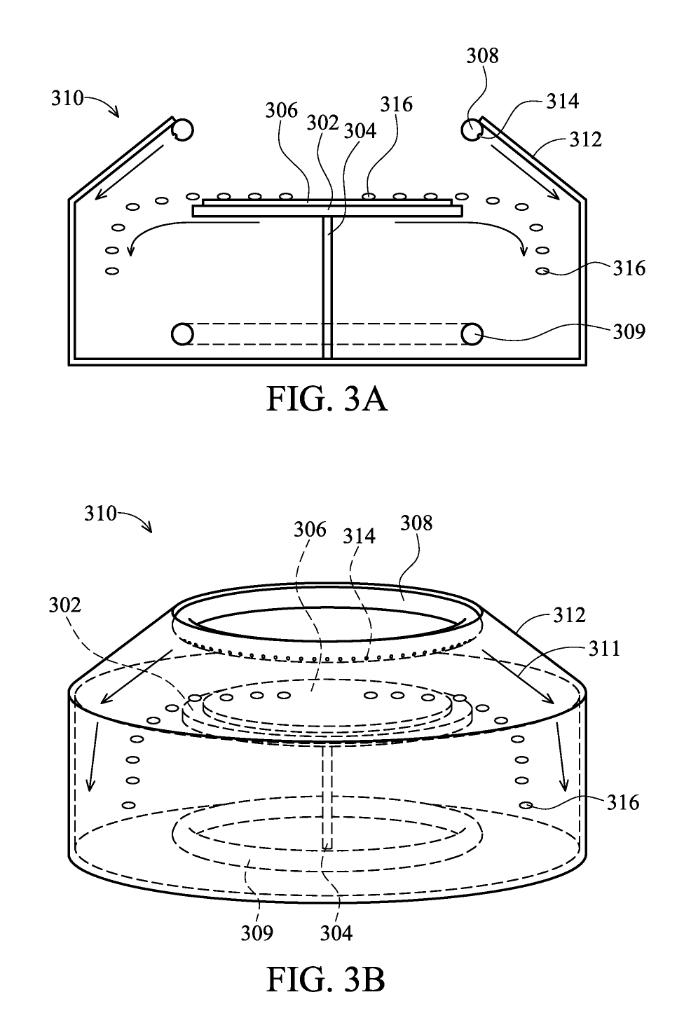

FIG. 3A shows a cross section view of a wafer scrubber apparatus of an embodiment of the invention. FIG. 3B shows a three dimensional view of a wafer scrubber apparatus of an embodiment of the invention. Referring to FIGS. 3A and 3B, a wafer holder 302 is connected to a spindle 304 in a chamber 310. A wafer 306 is disposed on the wafer holder 302. The wafer 306 may be moistened by deionized water 316 (DI water) in a preceding stage. The wafer holder 302 and the wafer 306 spin with a high speed to remove water 316 from the wafer 306 surface. In an embodiment of the invention, rotation speed of the wafer 306 can be 1500 rpm˜4500 rpm. Moreover, the wafer 306 is separated from the chamber wall 312 by a distance of about 30 mm˜150 mm. In an embodiment of the invention, the holder 302 holds the wafer 306 by an electric force or clamping. In a further embodiment of the invention, the chamber wall 312 is formed of hydrophilic materials.

In an important aspect of the embodiment, a gas purge pipe 308 including a plurality of gas injecting holes 314 is disposed at the top of the chamber wall 312, and an exhaust piping 309 is disposed at the bottom of the chamber 310. In more detail, both the gas purge pipe 308 and the exhaust piping 309 are ring-shaped, and the gas purge pipe 308 surrounds the top of the chamber wall 312 with a plurality of gas injecting holes 314 facing downward and with a direction extending along the chamber wall 312. Therefore, the gas purge pipe 308 can perform a gas purge along the chamber wall 312 making the water 316 from the wafer 306 flow along the chamber wall 312 more smoothly and quickly (arrows 311 in this figure indicate gas flow). Accordingly, the chamber wall 312 (may be formed of hydrophilic materials) can be dried more quickly and more water 316 can be caught by the chamber wall 312 to prevent water from scattering back to the wafer 306. In an embodiment of the invention, the purge gas comprises N₂, Ar.

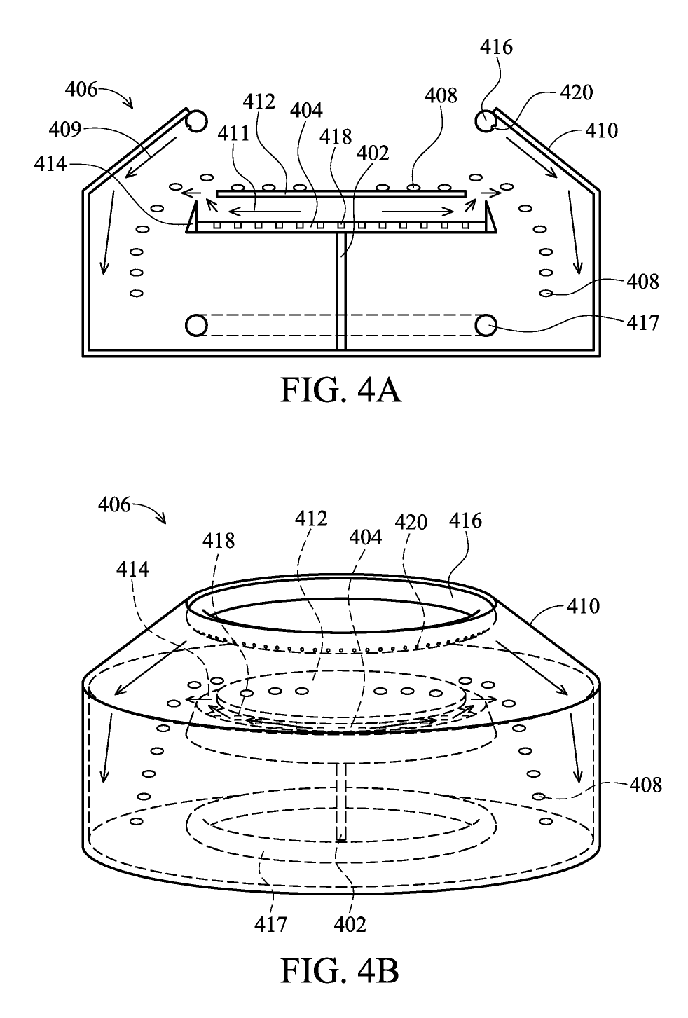

FIG. 4A shows a cross section view of a wafer scrubber apparatus of another embodiment of the invention. FIG. 4B shows a three dimensional view of a scrubber apparatus of the embodiment of the invention. Referring to FIGS. 4A and 4B, a wafer holder 404 is connected to a spindle 402 in a chamber 406. A wafer 412 is disposed on the wafer holder 404. The wafer 412 may be moistened by deionized water 408 (DI water) in a preceding stage. The wafer holder 404 and the wafer 412 spin with a high speed to remove water 408 from the wafer 412 surface. In an embodiment of the invention, rotation speed of the wafer 412 can be 1500 rpm˜4500 rpm. Moreover, the wafer 412 is separated from the chamber side wall 410 by a distance of about 30 mm˜150 mm. In an embodiment of the invention, the holder 404 holds the wafer 412 by an electric force or clamping using a clamper 414. In a further embodiment of the invention, the chamber wall 410 is formed of hydrophilic materials.

In the embodiment, a gas purge pipe 416 including a plurality of gas injecting holes 418 surrounds the top of the chamber wall 410, and an exhaust piping 417 is disposed at the bottom of the chamber 406, wherein both the gas purge pipe 416 and the exhaust piping 417 are ring-shaped, and the gas injecting holes 420 of the gas purge pipe 416 face downward and with a direction extending along a direction of the chamber wall 410 (arrows 409 in this figure indicate gas flow). Therefore, the gas purge pipe 416 can perform a gas purge along the chamber wall 410 making the water 408 from the wafer 412 flow along the chamber wall 410 more smoothly and quickly. In an important aspect of the embodiment, the wafer holder 404 includes a plurality of gas purge holes 418 to purge gas to the backside of the wafer 412 for preventing scrubber water 408 from flowing to the wafer 412 backside (arrows 411 in this figure indicate the gas flow). With the gas purge pipe 416 on top the chamber wall 410 and the gas purge holes 418 in the wafer holder 404, the embodiment can use gas flow to control water 408 flow to prevent water 408 from scattering back to the wafer 412. Therefore, the water 408 scattering back issue can be eliminated.

While the invention has been described by way of example and in terms of the preferred embodiments, it is to be understood that the invention is not limited to the disclosed embodiments. It is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wafer scrubber apparatus, comprising:
a chamber;
a holder connecting to a spindle disposed in the chamber, wherein the holder supports a wafer; and
a gas purge pipe disposed at the top of a wall of the chamber, wherein the gas purge pipe comprises a plurality of gas injection holes facing downward to purge gas along the chamber wall making water flow along the chamber wall more smoothly and more quickly for preventing the water from scattering back to the wafer.

2. The wafer scrubber apparatus as claimed in claim 1, wherein the wafer holder comprises a plurality of gas purge holes to purge gas to a backside of the wafer for preventing the water from flowing to the backside of the wafer.

3. The wafer scrubber apparatus as claimed in claim 1, wherein the chamber is formed of hydrophilic material.

4. The wafer scrubber apparatus as claimed in claim 1, wherein the holder holds the wafer by an electric force or clamping.

5. The wafer scrubber apparatus as claimed in claim 1, wherein the wafer is separated from the chamber wall by a distance of about 30 mm˜150 mm.

6. The wafer scrubber apparatus as claimed in claim 3, wherein the chamber wall formed of hydrophilic material is dried more quickly according to the gas purge and the volume of water caught by the chamber wall is increased to prevent water from scattering back to the wafer.

7. The wafer scrubber apparatus as claimed in claim 1, wherein the gas purge pipe surrounds the top of the wall of the chamber.

8. The wafer scrubber apparatus as claimed in claim 1, wherein the wafer is deionized (DI) water.

9. A wafer cleaning procedure, comprising:
providing a wafer scrubber apparatus, comprising a chamber, and holder connecting to a spindle disposed in the chamber, wherein the holder supports a wafer and a gas purge pipe disposed at the top of a wall of the chamber; and
spinning the wafer to remove water thereon, wherein the gas purge pipe purges gas along the wall of the chamber making water flow along the wall of the chamber more smoothly and more quickly for preventing the water from scattering back to the wafer.

10. The wafer cleaning procedure as claimed in claim 9, further comprising purging gas to a backside of the wafer for preventing the water from flowing to the backside of the wafer.

11. The wafer cleaning procedure as claimed in claim 9, wherein a wall of the chamber is formed of hydrophilic material.

12. The wafer cleaning procedure as claimed in claim 9, wherein the holder holds the wafer by an electric force or clamping.

13. The wafer cleaning procedure as claimed in claim 9, wherein the wafer is separated from the wall of the chamber by a distance of about 30 mm˜150 mm.

14. The wafer cleaning procedure as claimed in claim 11, wherein the wall of the chamber formed of hydrophilic material is dried more quickly according to the gas purge and volume of water caught by the chamber wall is increased to prevent water from scattering back to the wafer.

15. The wafer cleaning procedure as claimed in claim 9, wherein the gas purge pipe surrounds the top of the wall of the chamber.

16. The wafer cleaning procedure as claimed in claim 9, wherein the wafer is deionized (DI) water.
